(19) United States
(12) Patent Application Publication
(10) Pub. No.: US 2019/0185330 A1
(43) Pub. Date: Jun. 20, 2019

(54) PRODUCTION OF ZEOLITE-BASED COMPOSITE MATERIALS WITH HIERARCHICHAL POROSITY

(71) Applicant: Friedrich-Alexander-Universität Erlangen-Nürnberg

(72) Inventors: Wilhelm SCHWIEGER, Spardorf (DE); Martin HARTMANN, Herzogenaurach (DE); Michael KLUMPP, Erlangen (DE); Albert Gonche Fortunatus MACHOKE, Erlangen (DE); Tobias WEISSENBERGER, Erlangen (DE)

(21) Appl. No.: 16/087,374

(22) PCT Filed: Mar. 20, 2017
(86) PCT No.: PCT/EP2017/056533

§ 371 Date: Sep. 21, 2018

(30) Foreign Application Priority Data
Mar. 24, 2016 (DE) 102016003731.8

(51) Int. Cl. C01B 37/00; B01J 37/02; B01J 37/00; B01J 29/035; B01J 20/10; B01J 20/30; B01J 20/32

(52) U.S. Cl. CPC C01B 37/005; B01J 37/0225; B01J 37/0246; B01J 37/0228; B01J 37/0018; B01J 29/035; B01J 2229/60; B01J 20/3057; B01J 20/3204; B01J 20/3225; B01J 20/3238; B01J 2229/66; B01J 20/103

(57) ABSTRACT

A method is provided for generating a composite material with a support structure and a coating on the surface of the support structure, the coating comprising, as active component, crystals of a zeolite material or of a zeolite-like material, with intercrystalline mesopores and/or macropores being formed in the coating,
characterized in that the method comprises the following steps:
a) providing a suspension which comprises nanoscale starting crystals of a zeolite material or of a zeolite-like material, and also precursor compounds of the zeolite material or zeolite-like material,
b) applying the suspension provided in step a) to the surface of the support structure,
c) compacting the suspension applied in step b) by at least partially removing the solvent that forms the liquid phase of the suspension, to yield a coating which comprises the starting crystals and the precursor compounds,
d) keeping the coating obtained in step c) on the surface of the support structure in a vapor-containing atmosphere at an elevated temperature, so that the precursor compounds present are converted into a zeolite material or a zeolite-like material and, together with the starting crystals, form the coating which comprises crystals of a zeolite material or of a zeolite-like material.

This application is a national phase application under 35 U.S.C. § 371 of International Application No. PCT/EP2017/056533, filed Mar. 20, 2017, which claims benefit of German Application No. 102016003731.8, filed Mar. 24, 2016, the entire contents of each of which are hereby incorporated by reference.

The present invention relates to a method for providing a composite material that involves providing a support structure with a coating which comprises a zeolitic component or zeolite-like component with a controlled intracrystalline and intercrystalline porosity.

The method most widespread in the art for producing a composite material which comprises at least one active zeolitic or zeolite-like component and also a support structure is the coating of the support structure with the aid of a suitable binder material. Conventionally, such active (catalytic or sorptive) composite materials are produced by the coating of a usually ceramic support structure with a suspension—referred to as the “washcoat”—which comprises a binder material together with the active component (e.g. zeolite). The coating step is followed by suitable aftertreatment (temperature treatment), through which the binding material then develops its binding effect (e.g. B. Mitra and D. Kunzru: Washcoating of Different Zeolites on Cordierite Monoliths. In: Journal of the American Ceramic Society, 2008 (91) 64-70). As an industrially relevant example of the use of such a composite material, mention may be made here of the zeolite-coated ceramic honeycombs, of the kind used in applications including the removal of nitrogen oxides from exhaust gas flows. Besides the stated coating of support structures, shaping to produce granules or extrudates for catalytic or sorptive fixed-bed applications, for example, may be understood as a special case of the supported composite material, in which the support effect is performed by the interplay of binder and active component itself (“self-supporting system”).

Regardless of whether the system under consideration is self-supporting or supported, a disadvantage of such materials is that of reducing the activity of the resultant material as a result of the dilution of the active component (zeolite) with the binder material (binder).

One method which attempts to avoid this disadvantage but as yet does not enjoy large-scale application is the crystallization or reactive crystallization of the zeolitic active component onto an inert or reactive support structure. Intrinsically, however, this method is limited to active materials which, in chemical and structural standpoint offer the possibility of crystallization. Typical examples of such are therefore, among others, aluminum-containing and silicon-containing support materials. Although binder-free composite materials can be produced in this way (e.g. J. Bauer, R. Herrmann, W. Mittelbach and W. Schwieger: Zeolite/aluminum composite adsorbents for application in adsorption refrigeration. In: International Journal of Energy Research, 2009 (33) 1233-1249; S. Ivanova, B. Louis, B. Madani, J. P. Tessonnier, M. J. Ledoux and C. Pham-Huu: ZSM-5 coatings on β-SiC monoliths: Possible new structured catalyst for the methanol-to-olefins process. In: Journal of Physical Chemistry C, 2007 (111) 4368-4374), this method is nevertheless subject to severe limitations regarding the selection of supports and also the support/active component combination. Moreover, particularly in the case of crystallization on an inert support material, a considerable amount of excess powder is formed which makes no contribution to the actual production of the composite material (e.g. A. Zampieri, A. Dubbe, W. Schwieger, A. Avhale and R. Moos: ZSM-5 zeolite films on Si substrates grown by in situ seeding and secondary crystal growth and application in an electrochemical hydrocarbon gas sensor. In: Microporous and Mesoporous materials, 2008 (111) 530-535).

Furthermore, conventional methods are subject to limitations in so far as in particular the synthesis of nanoscale zeolites can be performed only up to a maximum conversion of well below 100% in respect of the network-forming atoms. For instance, reports degrees of conversion the literature for the zeolite ZSM-5 (crystal size around 100 nm) of up to a maximum of 65% (C. S. Tsay and A. S. T. Chiang: The synthesis of colloidal zeolite TPA-silicalite-1. In: Microporous and Mesoporous materials, 1998 (26) 89-99; A. E. Persson, B. J. Schoeman, J. Sterte and J. E. Otterstedt: The synthesis of discrete colloidal particles of TPA-silicalite-1. In: Zeolites, 1994 (14) 557-567), resulting in separation methods. One possibility of avoiding this limitation is the “top-down” approach, in which the nanoscale condition is produced by grinding of large zeolite crystals. In that case, however, there is a distinct reduction in the crystallinity of the resultant nanocrystals, giving rise to a need for recrystallization (T. Wakihara, A. Ihara, S. Inagaki, J. Tatami, K. Sato, K. Komeya, T. Meguro, Y. Kubota and A. Nakahira: Top-Down Tuning of Nanosized ZSM-5 Zeolite Catalyst by Bead Milling and Recrystallization. In: Crystal Growth & Design, 2011 (11) 5153-5158). The latter, however, is economically and ecologically disadvantageous.

It was an object of the present invention, therefore, to provide a method which can be used to apply zeolite materials or zeolite-like materials efficiently to support structures, without the need to use and add a binder material. The method, furthermore, ought to permit the generation of desired porosity properties.

As a solution of this problem, the present invention provides a method for generating a composite material with a support structure and a coating on the surface of the support structure, the coating comprising, as active component, crystals of a zeolite material or of a zeolite-like material, with intercrystalline mesopores and/or macropores being formed in the coating. The method of the invention comprises the following steps:
a) providing a suspension which comprises nanoscale starting crystals of a zeolite material or of a zeolite-like material, and also precursor compounds of the zeolite material or zeolite-like material,
b) applying the suspension provided in step a) to the surface of the support structure,
c) compacting the suspension applied in step b) by at least partially removing the solvent that forms the liquid phase of the suspension, to yield a coating which comprises the starting crystals and the precursor compounds,
d) keeping the coating obtained in step c) on the surface of the support structure in a vapor-containing atmosphere at an elevated temperature, so that the precursor compounds present are converted into a zeolite material or a zeolite-like material and, together with the starting crystals, form the coating which comprises crystals of a zeolite material or of a zeolite-like material.

According to one preferred embodiment, providing of the suspension in step a) takes place by synthesis of the starting crystals by partial reaction of a reaction mixture which comprises (i) a solvent, (ii) the precursor compounds of the zeolite material or zeolite-like material, and also preferably (iii) a template species. The suspension thus provided, with the starting crystals and unreacted precursor compounds present in the suspension, is subsequently applied in step b) to the surface of the support structure without prior isolation of the synthesized starting crystals. Accordingly, the method of this preferred embodiment comprises the following steps:
a) providing a suspension which comprises nanoscale starting crystals of a zeolite material or of a zeolite-like material, and also precursor compounds of the zeolite material or zeolite-like material, by synthesizing the starting crystals by partial reaction of a reaction mixture which comprises (i) a solvent, (ii) the precursor compounds of the zeolite material or zeolite-like material, and also preferably (iii) a template species,
b) applying the suspension provided in step a), with the starting crystals and unreacted precursor compounds present therein, to the surface of the support structure, without prior isolation of the synthesized starting crystals,
c) compacting the suspension applied in step b) by at least partially removing the solvent that forms the liquid phase of the suspension, to yield a coating which comprises the starting crystals and the precursor compounds,
d) keeping the coating obtained in step c) on the surface of the support structure in a vapor-containing atmosphere at an elevated temperature, so that the precursor compounds present are converted into a zeolite material or a zeolite-like material and, together with the starting crystals, form the coating which comprises crystals of a zeolite material or of a zeolite-like material.

With the aid of this method it is possible to apply zeolite materials or zeolite-like materials efficiently to support structures without any need to use a binder material to be added. The method of the invention opens up the possibility of optimized tailoring of the porosity characteristics and activity characteristics (e.g., of catalytic and/or sorptive nature) of the applied material for a potential application: for instance, the porosity which is established in the composite material is dictated on the one hand by a the porosity of the active material itself (microporous zeolite, for example) and on the other hand by the porosity of the layer constructed from it, and also by a porosity potentially present in the support material (for example three-dimensional, open, cellular structure), and so ultimately it is possible to bring about a hierarchy in the pore size by adaptation of process parameters and material parameters. Moreover, the method of the invention opens up the possibility of establishing a multifunctionality of the applied material through combinations of different active components or precursors thereof in the suspension itself, thereby replacing costly and inconvenient methods such as, for example, ion exchange or impregnation.

In particular by means of the above-described preferred embodiment wherein a suspension of nanocrystals and precursor material is generated and is subsequently applied as a coating, without isolation of the nanocrystals, to the surface of the support structure, it is possible, furthermore, associate extremely high efficiency of the method, in terms of the physical utilization of the starting materials for the synthesis of nanoscale zeolite materials or zeolite-like materials. Hence it is possible surprisingly to achieve degrees of conversion of up to 100% in respect of the network-forming atoms. Full conversion in respect of the network-forming components thus opens up the possibility of dispensing with methods for removing the nanoscale product from the unreacted components in the product suspension, with massive savings in relation both to time-consuming and costly separation methods and also in relation to the use of substances.

Lastly, the application of a coating in step a) can be accomplished by common methods, and without the applied coating undergoing macroscopic changes in the further course of the method (for example, local propagation of the layer by “running” of the coating or the like). Hence the possibility is provided as well of applying material with the aforementioned benefit in a locally limited way onto a support structure.

The method of the invention for generating a composite material with a support structure and a coating on the surface of the support structure, the coating comprising, as active component crystals of a zeolite material or of a zeolite-like material, with intercrystalline mesopores and/or macropores being formed in the coating,
is characterized in that the method comprises the following steps:
a) providing a suspension which comprises nanoscale starting crystals of a zeolite material or of a zeolite-like material, and also precursor compounds of the zeolite material or zeolite-like material,
b) applying the suspension provided in step a) to the surface of the support structure,
c) compacting the suspension applied in step b) by at least partially removing the solvent that forms the liquid phase of the suspension, to yield a coating which comprises the starting crystals and the precursor compounds,
d) keeping the coating obtained in step c) on the surface of the support structure in a vapor-containing atmosphere at an elevated temperature, so that the precursor compounds present are converted into a zeolite material or a zeolite-like material and, together with the starting crystals, form the coating which comprises crystals of a zeolite material or of a zeolite-like material.

The method of the invention is suitable for use with a multiplicity of support structures in a multiplicity of forms. As a support structure it is possible, for example, to employ two-dimensionally extended structures such as plates, metal sheets or films. These structures may be planar or shaped. Further examples of suitable geometric forms of the support structure are granules, tubes, honeycombs, or open-cell foam-like structures. A certain roughness to the surfaces is also an advantage, since it promotes, for example, the stable attachment of the coating in the composite material. The support structure is preferably a porous structure, as for example a structure made from a material which has macropores.

Examples of suitable materials which may form the support structure or may be present therein are preferably silicate materials, ceramic materials, metallic materials, or combinations thereof.

The coating in the composite material formed in accordance with the invention may completely or partially cover the surface of the support structure. As mentioned above, one of the applications for which the method of the invention is suitable is that of applying a coating with crystals of a zeolite material or zeolite-like material in a locally limited fashion to parts of the surface of a carrier material, in order, for example, to bring about selective structuring of surfaces in this way.

The active component of the coating of the composite material formed in accordance with the invention comprises crystals of a zeolite material or a zeolite-like material, preferably crystals of a zeolite material. Activities which can be provided by means of such an active component on the surface of the composite material are familiar to the person skilled in the art. Zeolite materials and/zeolite-like materials, respectively, are characterized for example, by desired sorption properties and/or catalytic properties. Catalytic properties here may be achieved or enhanced, for example, with the incorporation of suitable catalytically active guest molecules into the zeolitic framework structure of the zeolite materials or zeolite-like materials.

Besides the crystals of a zeolite material or of a zeolite-like material, the coating of the composite material formed in accordance with the invention may comprise one or more further active components and/or one of more inert materials. However, the coating may also consist of the crystals of a zeolite material or of a zeolite-like material, preferably the crystals of a zeolite material. As is apparent from the advantages of the invention elucidated at the outset, it is especially preferred that the coating of the composite material formed in accordance with the invention, and also the precursors or intermediates formed in its production in steps a), b) and c) of the method of the invention, be free from binder material. In this case, of course, the zeolite material or the zeolitic material and/or the precursor compounds thereof are not encompassed by the concept of the term binder material.

In the following, the composition of a zeolite material or zeolite-like material for use in the context of the present invention shall be explained. Unless otherwise indicated, these details are valid both for the crystals of a zeolite material or zeolite-like material in the coating of the composite material produced as an end product of the method of the invention, and also to the starting crystals of a zeolite material or of a zeolite-like material that are employed in step a) of the method.

The zeolite material and the zeolite-like material have a zeolitic framework structure. Such framework structures are known to the person skilled in the art. They comprise channels and/or cages which are connected by openings (pores) and are suitable, for example, for the incorporation of guest molecules.

Zeolite material in this case typically refers to a material having a zeolitic framework structure which is formed from Si, O and optionally Al. Silicon atoms (Si), oxygen atoms (O) and optionally aluminum atoms (Al) are typically the only elements from which the zeolitic framework structure in the zeolite material is formed. In the zeolitic framework structure of a zeolite material, silicon oxide tetrahedra and optionally aluminum oxide tetrahedra are connected via common oxygen atoms. While the composition of the individual tetrahedra can be represented as SiO₄ or AlO₄, the stoichiometry of the oxide components in the zeolite material is generally indicated by the formula SiO₂ or SiO_{4/2}, or AlO₂ or AlO_{4/2}, respectively.

A zeolite-like material refers to a material which likewise has a zeolitic framework structure, but may be formed not only from Si, O and optionally Al. Rather, other elements may be involved in the framework structure, or may form said structure, besides Si, O and optionally Al. These other elements are typically elements which may be present in tetrahedral coordination and which are capable, for example, of forming an oxidic network (also referred to here as “network-forming element”). Typical network-forming elements, which besides Si and optionally Al are suitable for providing a zeolitic framework material, are other elements of the 3rd, 4th and 5th main groups of the periodic table (groups 13, 14 and 15 according to current IUPAC classification). Examples are one or more elements selected from P, B, Ti and Ga. Other materials understood by the person skilled in the art to be zeolite-like include those which in the extreme case may also contain no Si, but which instead form tetrahedral networks of aluminum and phosphorus, for example, such as the so-called aluminum phosphates (AIPO-n materials), and are able to form identical or similar structures to those possessed by the conventional zeolites. The zeolitic framework structure of a zeolite-like material is preferably formed from Si, O, optionally Al, and one or more elements selected from P, B, Ti and Ga.

In connection with the composite material provided in accordance with the invention and with the starting crystals used in accordance with the invention, zeolite materials and zeolite-like materials are also referred to by the common generic term “zeolitic materials”.

As is familiar to the person skilled in the art, the zeolitic framework structure of zeolite materials and zeolite-like materials is formed by tetrahedral base units, which are connected via common oxygen atoms. In these tetrahedral base units, one atom T is surrounded by four oxygen atoms, which, however, are each shared by adjacent tetrahedra, so that the base units are also described by the formula TO₂, or TO_{4/2}. In this case, T denotes an element which is capable of forming an oxidic network and which can be in tetrahedral coordination (also referred to here as “network-forming element”). Typical network-forming elements, the oxides of which are suitable for forming zeolite materials and zeolite-like materials, are elements of the 3rd, 4th and 5th main groups of the periodic table (groups 13, 14 and 15 according to current IUPAC classification). Examples are one or more elements selected from Si, Al, P, B, Ti, or Ga. If trivalent atoms T occur in the framework structure in the form of connected tetrahedra TO₂, for example Al, B or Ti, they carry a negative formal charge. This charge is generally balanced by the presence of cations, in which case cations of one type or cations of different types may be used.

Preferably, the zeolitic framework structure in the crystals of the zeolite material or of the zeolite-like material in the coating of the composite material provided in accordance with the invention and in the starting crystals is formed from tetrahedral SiO₂ units, and silicon atoms in the framework structure may be replaced by one or more other network-forming elements selected from elements of main groups 3, 4 and 5 of the periodic table (groups 13, 14 and 15 according to current IUPAC classification). Preferably, the other network-forming elements are one or more elements selected from boron, aluminum, phosphorus and titanium. More preferably, the zeolitic framework structure is formed from tetrahedral SiO₂ units, wherein silicon atoms in the framework structure may be replaced by aluminum, or it is formed exclusively from SiO₂ units. Typically, not more than 30%, preferably not more than 20% and more preferably not more than 10% of all the silicon atoms in the zeolitic framework structure are replaced by other elements. In this case, the percentage relates to the number of all network-forming atoms, and therefore all tetrahedrally coordinated positions in the zeolitic framework structure, as 100%.

The cations for charge balancing of formal charges possibly present in the framework structure are preferably selected from alkaline metal cations, alkaline-earth metal cations or ammonium cations. One characteristic feature of zeolites, or of a zeolitic material, is the mobility or exchangeability of the cations

As mentioned above, the zeolitic framework structure of the crystals of the zeolite material or zeolitic material in the coating and the starting crystals is preferably formed by connected SiO₂ tetrahedra (also referred to as SiO4/2) or by connected SiO₂ and AlO₂ (also referred to as SiO_{4/2} and AlO_{4/2}) tetrahedra. Although a certain number of the Si atoms may be replaced with other tetravalent atoms, and/or a certain amount of the Al atoms may be replaced with other trivalent atoms, it is more preferred for the framework structure to consist of the SiO₂ and AlO₂ tetrahedra, or only of SiO₂ tetrahedra, so that the crystals in question are crystals of a zeolite material. The structure of a zeolite material having such a zeolite framework may be represented by the formula M_{x/n}[(AlO₂)ₓ(SiO₂)_{y}] or M_{x/n}[(AlO₂)ₓ(SiO₂)_{y}].z H₂O. Here, M stands for one or more types of cations with the valency or charge n (for example, alkali metal cations and/or alkaline-earth metal cations, so that n is typically 1 or 2, and in the presence of alkali metal cations and alkaline-earth metal cations may also take on values between 1 and 2), and z H₂O stands for water molecules which may be adsorbed in the pores of the zeolite framework. The variables x and y stand for the proportion of neutral SiO₂ tetrahedra, and of negatively charged AlO₂ tetrahedra.

Zeolite materials suitable in accordance with the invention encompass pure silicate variants, which contain no Al or in which x in the formula stated above is 0. Suitable zeolite materials which comprise Si and Al typically have an Si/Al molar ratio (and in particular the ratio y/x in the formula above) of at least 1; for example, in the case of a high-silica zeolite material, the molar ratio is preferably at least 3.5, more preferably at least 10, and in particular at least 15.

Also as zeolite-like materials, preferably materials are used in which the molar ratio of the tetrahedrally coordinated Si atoms to the sum of the other tetrahedrally coordinated, network-forming atoms optionally present, such as boron, aluminum, phosphorus or titanium, in the zeolitic framework structure is at least 1. By way of example it is also possible here to identify high-silica materials. Generally speaking, the high-silica zeolite materials or zeolitic materials are characterized in that the molar ratio of the tetrahedrally coordinated Si atoms to the sum of the other tetrahedrally coordinated, network-forming atoms optionally present, such as boron, aluminum, phosphorus or titanium, in the zeolitic framework structure is preferably at least 3.5, more preferably at least 10, and in particular at least 15.

As is familiar to the person skilled in the art, depending on the selection of the framework constituents and the synthesis conditions, zeolite materials form characteristic framework structures for which particular type designations are established. Examples of high-silica zeolite materials which may be contained in the coating are those of the MFI, BEA, MOR, FER, MWW, MTW, DDR, CHA, AEI or MEL structure type. Particularly preferred as high-silica zeolite materials are zeolite materials of MFI and BEA type. Examples of aluminum-rich zeolite materials which may be present in the coating are zeolite A, X or Y, which are also abbreviated as LTA or FAU.

The coating in the composite material produced in accordance with the invention may comprise more than one zeolite material or zeolite-like material; for example, two different zeolite materials, two different zeolite-like materials, or a zeolite material and a zeolite-like material may be combined. Preferably there is exactly one zeolite material or exactly one zeolite-like material included, especially preferably exactly one zeolite material.

As mentioned above, the coating in the composite material produced in accordance with the invention may comprise one or more further active components together with the the crystals of a zeolite material or of a zeolite-like material. As examples of further active components, mention may be made of e.g. metals, especially metals or transition metals such as Fe, Co, Ni, Mo, Zn, Ti, Cu, Ru, Rh, Pd or Pt. They may be present e.g. in the form of metal particles. Such particles, if present, are preferably nanoparticles with a size—determined for example by means of electron micrographs—of less than 1 μm, more preferably 200 nm or smaller, and especially preferably 100 nm or smaller. Typically the size is 20 nm or larger, preferably 30 nm or larger. Other examples of further active components are metal compounds, e.g. compounds of the metals and transition metals, respectively, exemplified above, such as e.g. oxides or sulfides, for example. Metal compounds or transition metal compounds may also be included in the coating, for example in the form of metal particles, like the aforementioned nanoparticles.

As mentioned above, the coating in the composite material produced in accordance with the invention may comprise one or more inert materials together with the crystals of a zeolite material. Such materials may be selected appropriately by the person skilled in the art according to the planned use of the composite material. As the person skilled in the art is aware, the term “inert” here refers to materials which behave inertly in this use. Preferably, however, the coating provided is free from such inert materials. Such an introduction of inert materials may be useful, for example, if the activity of the active species is high and if there is a need for local dilution for the purpose of control, e.g. of the supply or removal of heat, for example. Nevertheless, when using the method of the invention, it is possible to maintain the local intensive mixing and spatial closeness of the active species of a bi- or multi-functional combination of the active constituents.

The crystals of the zeolite material or of the zeolite-like material preferably form the main component of the coating in the composite material produced in accordance with the invention, meaning that they are present in a proportion of 50 wt % or more, more preferably 80 wt % or more, especially preferably 90 wt % or more, and very preferably 100 wt %, based on the total weight of the coating. The proportion by weight of the zeolite material or of the zeolite-like material here also includes any guest molecules possibly present therein, and/or any cations necessary in relation to the charge neutrality.

The crystals of the zeolite material or of the zeolite-like material in the coating in the composite material produced in accordance with the invention are typically nanoscale crystals, as in the case of the starting crystals. The crystal size, determined for example by means of electron micrographs, is not exclusively, yet preferably, smaller than 1 μm, more preferably 200 nm or smaller, and especially preferably 100 nm or smaller. Typically, the size is 20 nm or larger, preferably 30 nm or larger.

Crystal sizes may be determined, for example, by means of image analysis using scanning electron micrographs. For this purpose, it is possible to employ the approach of the equivalent diameter of a sphere with an equal projection area. To this end, the projection areas Aₚᵣₒⱼ of N crystals are ascertained on the SEM micrographs by means of suitable image analysis software (for example “ImageJ”; cf. Rasband, W. S., ImageJ, U.S. National Institutes of Health, Bethesda, Md., USA, http://imagej.nih.gov/ij/, 1997-2015) (here: crystal projections approximated as ellipses), and the equivalent sphere diameter is calculated according to the following equation:

$${d}_{eq} = \sqrt{\frac{{A}_{proj}}{π}}$$

From the resulting N equivalent diameters it is also possible to determine the cumulative size distribution Q and/or size density distribution q, and to calculate and specify the corresponding average diameter d_{eq,mean}. Unless otherwise indicated, the crystal size reported is the mean equivalent diameter of the crystals. The equivalent diameter of all the crystals is preferably within the above-stated size ranges and preferred size ranges, respectively.

It should be noted here that the particles apparent as individual crystals on the SEM micrographs (may) consist, in crystallographic terms, of a plurality of crystallites. The size of these identically constructed, coherent crystal-region crystallites can be estimated on the basis, for example, of the X-ray diffractogram, from the full widths at half-maximum of the X-ray reflections.

The crystals of the zeolite material or zeolite-like material in the coating of the composite material provided in accordance with the invention typically have a microporous framework structure. As is characteristic of zeolitic structures, the micropores of the framework structure form a pore system of interconnected micropores. Unless otherwise explained in any individual case, the reference to micropores is made on the basis of the IUPAC convention, where micropores are identified as pores having a pore diameter dp up to <2 nm, mesopores are pores having a diameter dp of 2 to 50 nm and macropores are pores having a diameter of more than 50 nm) [Haber et al. IUPAC, Pure and Appl. Chem., 63 (1991) 1227]. The pore diameters can be determined, for example, by means of sorption methods using gases.

As a result of the production method according to the invention, the crystals of the zeolite material or zeolite-like material are arranged in the coating of the composite material provided in such a way that the interstices between the crystals form the intercrystalline mesopores and/or macropores of the coating. As elucidated above, the designation is guided by the IUPAC convention—that is, mesopores are pores having a pore diameter dp of 2 to 50 nm, and macropores are pores having a diameter of more than 50 nm. Typically, the crystals of the zeolite material or zeolite-like material are present in the coating of the composite material provided in such a way that they are still perceptible as individual crystals e.g. in electron micrographs of the coating, although these individual crystals are preferably in mutual contact or more preferably have grown together with one another.

Hence it is possible, with the method of the invention, to provide a composite material having a controlledly hierarchical porosity. Micropores present are defined by the type of zeolite material or zeolite-like material used; mesopores and/or macropores are defined, for example, by the amount and size of the crystals of the zeolite material or zeolite-like material and their resultant arrangement during coating.

The thickness of the coating may be adjusted over wide ranges in accordance with requirements, optionally by multiple coating. The thickness of the coating is typically in a range from 20 nm to to 200 μm. The thickness may be determined, for example, by means of cross-section image analysis, typically with the aid of an SEM micrograph.

For producing the composite material in accordance with the invention, first of all in step a) a suspension is provided which comprises nanoscale starting crystals of a zeolite material or of a zeolite-like material, and also precursor compounds of the zeolite material or zeolite-like material. Preferably, nanoscale starting crystals of a zeolite material and also precursor compounds of the zeolite material are contained. As will be appreciated by the person skilled in the art, the precursor compounds in the suspension are typically selected such that they can be used to form a zeolite material or zeolite-like material whose composition corresponds to the material present in the suspension.

The crystal size of the nanoscale starting crystals, determined for example from electronmicrographs as explained above for the crystals of the coating, is preferably smaller than 1 μm, more preferably 200 nm or smaller, and especially preferably 100 nm or smaller. The size is typically 20 nm or larger, preferably 30 nm or larger. The values are preferably stated in each case as the mean equivalent diameter. More preferably, the equivalent diameter of all the crystals is within the above-stated size ranges or preferred size ranges.

With regard to the composition of the starting crystals composed of a zeolite material or of a zeolite-like material, preferably of a zeolite material, the elucidations made above in relation to the composition both of the starting crystals and of the crystals of the zeolite material or zeolite-like material in the coating provided apply. The composition of the starting crystals typically corresponds to that of the crystals of the zeolite material or zeolite-like material in the coating provided.

Precursor compounds of zeolite materials or zeolite-like materials, as present in the suspension provided in step a), are likewise familiar to the person skilled in the art. Typically they are compounds of network-forming elements which are in solution or in suspension, in colloidal form or as amorphous solids, in the solvent that forms the liquid phase of the suspension. Typical network-forming elements whose oxides are suitable for providing zeolite materials and zeolite-like materials are elements of main groups 3, 4 and 5 of the periodic table (groups 13, 14 and 15 according to current IUPAC classification). Preferred examples are one or more elements selected from Si, Al, P, B, Ti, or Ga; more strongly preferred examples are Si and Al.

Examples of suitable compounds of these network-forming elements are salts, including metallates, hydroxides or alkoxides. Specific exemplary silicon compounds suitable as precursor compounds are silicic acids, salts of silicic acid or silicic acid esters (such as tetraethyl orthosilicate, for example). The silicic acid embraces not only orthosilicic acid but also oligomeric and/or solid polycondensation products thereof, such as silica gels, precipitated silicas or Aerosil. Exemplary aluminum compounds suitable as precursor compounds are aluminum salts such as aluminum nitrate, aluminates such as, for example, alkali metal aluminates, aluminum alkoxides such as, for example, aluminum triisopropoxide, or aluminum hydrates, such as, for example, aluminum trihydrate. Exemplary titanium compounds are titanium salts, titanates, titanium tetraethoxide, titanium alkoxy compounds, such as titanium isopropoxide. Exemplary phosphorus compounds are phosphates and phosphoric acid esters. Exemplary boron compounds are boric acid, borates or boric acid esters, such as triethyl borate or trimethyl borate, for example.

Besides the starting crystals and the precursor compounds, the suspension that is provided in step a) preferably comprises a template species, i.e. a substance which is able to act as a template for the synthesis of a zeolitic framework structure. This compound is preferably an organic compound.

Suitable organic compounds, also referred to as organic templates or as structure-directing substances, are known to the person skilled in the art. They are generally alcohols, phosphorus compounds, amines or ammonium compounds, preferably tetraorganoammonium cations or tetraorganophosphonium cations, which are used typically in the form of their salts, for example as halides or hydroxides.

More preferably, they are tetraorganoammonium cations or tetraorganophosphonium cations which carry four hydrocarbon radicals, in particular hydrocarbon radicals which are selected independently of one another from alkyl radicals, aryl radicals and alkaryl radicals. Preferably, the alkyl radicals are C1-C4 alkyl radicals. The phenyl radical is preferred as an aryl radical, and the benzyl radical is preferred as an alkaryl radical. Tetralkylammonium cations are particularly preferably used as tetraorganoammonium cations, such as the tetramethylammonium cation, for example in the form of tetramethylammonium hydroxide, the tetraethylammonium cation, for example in the form of tetraethylammonium hydroxide, the tetrapropylammonium cation, for example in the form of tetrapropylammonium hydroxide, the tetrabutylammonium cation, or the triethylmethylammonium cation. Further preferred examples of are the tetrabutylphosphium cation, the triphenylbenzylphosphonium cation or the trimethylbenzylammonium cation. Besides these, for example, primary, secondary or cyclic amines (such as piperidine), imines (such as hexamethyleneimine) or alcohols may also be used as organic template species.

The following table gives a non-restrictive overview of conventional organic compounds as template species and the zeolitic framework structures obtainable using them:

| Organic molecules | Zeolites (network type) |
|---|---|
| TMA - (tetramethylammonium)⁺ | X (FAU), sodalite (SOD), |
| | ZSM-10 (MOZ), ZSM-3 (EMT- |
| | FAU), ZSM-5 (MFI), ZSM-11 |
| | (MEL), ZSM-39 (MTN) |
| TEA - (tetraethylammonium)⁺ | ZSM-5 (MFI), ZSM-11 (MEL), |
| | SAPO-34 (CHA), UZM-5 (UFI), |
| | ZSM-20 (EMT-FAU), ZSM-12 |
| | (MTW), beta (BEA) |
| TBP - (tetrabutylphosphonium)⁺ | ZSM-5 (MFI), ZSM-11 (MEL) |
| TPA - (tetrapropylammonium)⁺ | ZSM-5 (MFI), AlPO₄-5 |
| | (AFI), ZETA-1, ZETA-3 |
| TPBP - (triphenylbenzylphosphonium)⁺ | ZSM-11 (MEL) |
| TMBA - (trimethylbenzylammonium)⁺ | ZSM-11 (MEL) |
| TBA - (tetrabutylammonium)⁺ | ZSM-5 (MFI), ZSM-11 (MEL) |
| TEMA - (triethylmethylammonium)⁺ | ZSM-12 (MTW) |
| Primary and secondary amines | ZSM-5 (MFI), ZSM-22 (TON), |
| | ZSM-35 (FER) |
| Piperidine | ferrierite (FER) |
| HMI - (hexamethyleneimine) | PSH-3 (MWW), ZSM-5 (MFI), |
| | SAPO-35 (LEV) |
| Alcohols | ZSM-5 (MFI) |

If the presence of a further active component in the coating of the composite material is desired, it may likewise be included directly or in the form of a precursor compound in the suspension provided in step a). As mentioned above, examples of suitable further active components are metals, especially metals or transition metals such as Fe, Co, Ni, Mo, Ti, Zn, Cu, Ru, Rh, Pd or Pt. They may be included in the suspension in the form, for example, of metallic nanoparticles or in the form of a metal compounds. Metal compounds may be introduced, for example, in the form of an oxide or sulfide, in the form of a salt of a corresponding metal cation, or in the form of a complex compound of a corresponding metal.

If desired, the suspension may, furthermore, also comprise other materials, examples being inert materials, which are to be present in the coating of the composite material provided in accordance with the invention. With preference, however, both the suspension and the coating provided are free from such inert materials.

Additives which facilitate the processing of the suspension may also be employed, such as a dispersant, for example. As mentioned above, however, the suspension is typically free from a binder material or binder.

The solvent which forms the liquid phase of the suspension may be a single solvent or a mixture of two or more solvents. For reasons of cost-effectiveness and environmental compatibility, water is an especially suitable solvent.

To provide the suspension in step a), the nanoscale starting crystals, the precursor compound, preferably the template species as well, and further optional constituents may be added in any order to the solvent. In accordance with the preferred embodiment of the method, discussed above, however, it is particularly advantageous to provide the suspension by synthesizing the starting crystals in step a) by partial reaction of a reaction mixture which comprises (i) a solvent, and (ii) the precursor compounds of the zeolite material or zeolite-like material, and also, preferably, (iii) a template species as well. The result obtained is the suspension which comprises the nanoscale starting crystals of a zeolite material or zeolite-like material, precursor compounds of the zeolite material or zeolite-like material, and also, preferably, a template species as well. In step b), the suspension thus provided, with the starting crystals and unreacted precursor compounds present therein, is applied to the surface of the support structure, without the synthesized starting crystals being isolated beforehand.

Generally, the concentration of solids in typical suspensions is preferably not higher than 30% (weight/weight), more preferably not higher than 20%. For example, the concentration of solids may be in the range from 10 to 30% (weight/weight). The term “concentration of solids” refers here to the total concentration of all materials (especially the nanoscale starting crystals and precursor compounds of the zeolite material or zeolite-like material, but also further optional active components which are later present in solid form in the coating of the composite material. The concentrations of further constituents (e.g., auxiliary constituents such as template species) may be adapted in accordance with the desired structure in the coating).

This results, as a particularly preferred variant of the invention, in a method for generating a composite material with a support structure and a coating on the surface of the support structure, the coating comprising, as active component crystals of a zeolite material or of a zeolite-like material, with intercrystalline mesopores and/or macropores being formed in the coating,
characterized in that the method comprises the following steps:
a) providing a suspension which comprises nanoscale starting crystals of a zeolite material or of a zeolite-like material, and also precursor compounds of the zeolite material or zeolite-like material, by synthesizing the starting crystals by partial reaction of a reaction mixture which comprises (i) a solvent, (ii) the precursor compounds of the zeolite material or zeolite-like material, and also, preferably, (iii) a template species,
b) applying the suspension provided in step a), with the starting crystals and unreacted precursor compounds present therein, to the surface of the support structure, without the synthesized starting crystals being isolated beforehand,
c) compacting the suspension applied in step b) by at least partially removing the solvent that forms the liquid phase of the suspension, to yield a coating which comprises the starting crystals and the precursor compounds,
d) keeping the coating obtained in step c) on the surface of the support structure in a vapor-containing atmosphere at an elevated temperature, so that the precursor compounds present are converted into a zeolite material or a zeolite-like material and, together with the starting crystals, form the coating which comprises crystals of a zeolite material or of a zeolite-like material.

The synthesis of the nanoscale starting crystals by partial reaction of a reaction mixture which comprises (i) a solvent, and (ii) the precursor compounds of the zeolite material or zeolite-like material, and also, preferably, (iii) a template species as well, the synthesis in question is typically a symphosis carried out under hydrothermal conditions, as for example by crystallization of the starting crystals at a temperature which in general is not less than 70 to not more than 220° C., over a number of hours up to 5 days. It is important that the precursor compounds are not completely reacted, so that the suspension formed includes besides the starting crystals also unreacted precursor compounds. Preferably, a degree of conversion of 60-80 mol % ought to be achieved, based on the total number of moles of the network-forming elements in the original reaction mixture, as 100 mol % i.e. a suspension is preferably provided in which 60-80 mol % of the network-forming elements in the precursor compounds of the original reaction mixture have been reacted into nanoscale starting crystals.

In step b) of the method of the invention, the suspension provided in step a) is applied to the surface of the support structure. As methods for the application a number series of conventional methods are available, such as, for example (spin coating), (dip coating), knife coating, or spraying. As elucidated above, the suspension may be applied in such a way that the entire surface of the support structure is covered with the suspension, or such that the surface is only partly covered. Local application is likewise possible by means of the methods exemplified above, optionally supported by masking of parts of the surface on which no application is to take place.

In step c), a compaction of the suspension applied in step b) takes places, via an at least partial removal of the solvent which forms the liquid phase of the suspension, to yield a coating which comprises the starting crystals and the precursor compounds. Furthermore, the coating comprises further optional constituents, referred to above as optional constituents of the suspension, and particularly, as a preferred further constituent, the template species which permit control of structure formation for different types of zeolite or zeolitic framework structures, respectively.

The at least partial removal of the solvent may be accomplished by known methods, as for example by means of an increase in temperature, a reduction in the partial pressure of the solvent in the environment of the applied suspension, or combinations thereof. Besides heat and/or pressure reduction or vacuum, respectively, methods such as freeze-drying may also be employed.

To compact the suspension in step c), typically at least 40% by weight of the solvent, preferably at least 50% by weight of the solvent, more preferably at least 75% by weight of the solvent, and very preferably at least 85% by weight of the solvent is removed, based on the total weight of the solvent in the suspension for application. The proportion of solvent removed is typically, however, less than 100 wt %, so that a residual loading of solvent remains in the coating obtained in step c).

As and when necessary, e.g. in order to adjust the thickness of the coating, steps b) and c), and as the case may be also steps a), b) and c), of the method of the invention may be performed a plurality of times, for example two or three times, before step d) is carried out.

In step d) of the method of the invention, the coating obtained in step c) is kept on the surface of the support structure in a vapor-containing atmosphere at an elevated temperature, in order to thus to convert the precursor compounds of the zeolite material or zeolite-like material that are present in the coating into a corresponding zeolite material or zeolite-like material. Accordingly, together with the starting crystals, the converted precursor compounds form the coating which comprises crystals of a zeolite material or of a zeolite-like material.

In the conversion in step d), zeolite material or zeolite-like material formed from the precursor compounds typically grows onto starting crystals in the coating. This growth preferably takes place in such a way that the zeolite material or zeolite-like material additionally formed from the precursor compounds connencts the starting crystals in the coating and, consequently, the crystals of the zeolite material or zeolite-like material are in mutual contact in the coating of the invention and with particular preference have grown together with one another.

The vapor-containing atmosphere used in step d) is typically a water vapor-containing atmosphere. However, in step d), contact of the coating obtained in step c) with a liquid solvent, such as liquid water, for example, should be avoided. The water vapor content of the atmosphere is preferably at a relative humidity of 60 to 100%, more preferably 80 to 95%.

The elevated temperature in step d) is preferably in the range of 70 to 200° C., more preferably 100 to 170° C., and especially preferably 100 to 160° C.

According to one preferred embodiment, therefore, in step d), the coating obtained in step c) is kept on the surface of the support structure in a water vapor-containing atmosphere at a temperature of 100 to 170° C., the relative humidity of the atmosphere being in each case 60 to 100%.

The duration for which the coating obtained in step c) is kept in the vapor-containing atmosphere at elevated temperature in step d) may be selected by the person skilled in the art as a function of the type of zeolite material or zeolite-like material and of the temperature. The period is in general 0.5 to 192 hours, preferably, for example for a zeolite material of ZSM-5 type (MFI type), typically at 2 to 96 h, more preferably 10 to 72 h.

The coating obtained in step c) may be kept in the vapor-containing atmosphere at elevated temperature in step d) in an open system under atmospheric pressure, and so the partial pressures of the vaporous substances are determined by the amount thereof in the ambient air.

The maintenance of the coating obtained in step c) in the vapor-containing atmosphere at elevated temperature in step d) takes place preferably in a closed system, for example in an autoclave, in order thus to allow the composition of the vapor-containing atmosphere to be effectively controlled. The pressure within the closed system may in principle be below, above or at atmospheric pressure. When step d) is conducted in a water vapor-containing atmosphere at temperatures at or above 100° C., the pressure is typically situated above the atmospheric pressure.

The pressure and hence also the partial pressures of the vaporous components in the atmosphere when the coating obtained in step c) is kept on the surface of the support structure at an elevated temperature may be established in a targeted way, for example, autogenously via the phase equilibrium or the phase equilibria of the species present at the selected temperature, or by one or more internal or external regulating facilities or regulating measures. It is possible, for example, to use a regulating facility or regulating measure which is an apparatus, or of physical or chemical nature, or a combination of these. Where a water vapor-containing atmosphere is employed in step d), it is possible, for example, for the coated support material to be maintained in a closed system at an elevated temperature, to which liquid water has been added. Possibilities for the deliberate adjustment of the water vapor partial pressure include, for example, substances which are capable of reversible binding of water, such as, for example, salts and/or their hydrates, or silica gel.

Subsequent to step d) it is possible, as and when required, to carry out additional aftertreatment steps.

Especially when using an organic compound as template species in the suspension provided in step a), for example, it may be desirable, subsequent to step d), to remove template species still present from the resultant composite material by means of an aftertreatment, preferably a thermal aftertreatment.

Other aftertreatment steps familiar to the person skilled in the art for a composite material comprising as active component a zeolite material or zeolite-like material are, for example, one or more steps selected from calcination, extraction, thermal treatment, leaching, steam treatment, acid treatment, ion exchange, and mechanical shaping.

Important general (point 1) and preferred (points 2 to 33) embodiments of the present invention are summarized once again in the following points:

1. A method for generating a composite material with a support structure and a coating on the surface of the support structure, the coating comprising, as active component, crystals of a zeolite material or of a zeolite-like material, with intercrystalline mesopores and/or macropores being formed in the coating,
characterized in that the method comprises the following steps:
a) providing a suspension which comprises nanoscale starting crystals of a zeolite material or of a zeolite-like material, and also precursor compounds of the zeolite material or zeolite-like material,
b) applying the suspension provided in step a) to the surface of the support structure,
c) compacting the suspension applied in step b) by at least partially removing the solvent that forms the liquid phase of the suspension, to yield a coating which comprises the starting crystals and the precursor compounds,
d) yielding the coating obtained in step c) on the surface of the support structure in a vapor-containing atmosphere at an elevated temperature, so that the precursor compounds present are converted into a zeolite material or a zeolite-like material and, together with the starting crystals, form the coating which comprises crystals of a zeolite material or of a zeolite-like material.

2. The method according to point 1,
wherein the providing of the suspension in step a) takes place by synthesis of the starting crystals by partial reaction of a reaction mixture which comprises (i) a solvent, (ii) the precursor compounds of the zeolite material or zeolite-like material, and also preferably (iii) a template species,
and wherein the suspension thus provided, with the starting crystals and unreacted precursor compounds present therein, is applied in step b) to the surface of the support structure, without prior isolation of the synthesized starting crystals.

3. A method for generating a composite material with a support structure and a coating on the surface of the support structure, the coating comprising, as active component, crystals of a zeolite material or of a zeolite-like material, with intercrystalline mesopores and/or macropores being formed in the coating,
characterized in that the method comprises the following steps:
a) providing a suspension which comprises nanoscale starting crystals of a zeolite material or of a zeolite-like material, and also precursor compounds of the zeolite material or zeolite-like material, by synthesizing the starting crystals by partial reaction of a reaction mixture which comprises (i) a solvent, (ii) the precursor compounds of the zeolite material or zeolite-like material, and also, preferably, (iii) a template species,
b) applying the suspension provided in step a), with the starting crystals and unreacted precursor compounds present therein, to the surface of the support structure, without the synthesized starting crystals being isolated beforehand,
c) compacting the suspension applied in step b) by at least partially removing the solvent that forms the liquid phase of the suspension, to yield a coating which comprises the starting crystals and the precursor compounds,
d) keeping the coating obtained in step c) on the surface of the support structure in a vapor-containing atmosphere at an elevated temperature, so that the precursor compounds present are converted into a zeolite material or a zeolite-like material and, together with the starting crystals, form the coating which comprises crystals of a zeolite material or of a zeolite-like material.

4. The method according to point 2 or 3, wherein the synthesis of the starting crystals is a hydrothermal synthesis.

5. The method according to any of points 1 to 4, wherein the nanoscale starting crystals have a size of 20 to 200 nm, preferably 30 to 100 nm.

6. The method according to any of points 1 to 5, wherein the coating formed in step d) is a coating which is free from binder material.

7. The method according to any of points 1 to 6, wherein the zeolite material or zeolite-like material formed during the conversion in step d) grows onto starting crystals in the coating.

8. The method according to any of points 1 to 7, wherein the zeolite material or zeolite-like material formed in the conversion in step d) connects starting crystals in the coating.

9. The method according to any of points 1 to 8, wherein the coating comprises at least one additional active component which is selected from a transition metal or a transition metal compound.

10. The method according to point 9, wherein the additional active component is introduced into the coating by adding a transition metal or a transition metal compound to the suspension provided in step a).

11. The method according to any of points 1 to 10, wherein the support structure is formed from a silicate metallic or ceramic material.

12. The method according to any of points 1 to 11, wherein the support structure is present in the form of a planar or shaped plate, a tube, open-cell, foam-like structure or of a honeycomb.

13. The method according to any of points 1 to 12, wherein the coating comprises a zeolite material as active component, and wherein the suspension provided in step a) comprises nanoscale starting crystals of a zeolite material, and also precursor compounds of the zeolite material.

14. The method according to any of points 1 to 13, wherein the precursor compounds of the zeolite material or zeolite-like material in the suspension provided in step a) comprise at least one type of a silicon compound which is selected from silicic acid, salts of silicic acid and silicic acid esters.

15. The method according to according to any of points 1 to 14, wherein the precursor compounds of the zeolite material or zeolite-like material in the suspension provided in step a) comprise at least one type of an aluminum compound which is selected from aluminates, aluminum salts, hydrated aluminum and aluminum alkoxides.

16. The method according to any of points 2 to 15, wherein the template species comprises a tetraorganoammonium cation or a tetraorganophosphonium cation.

17. The method according to any of points 1 to 16, wherein the suspension provided in step a) additionally comprises a dispersant.

18. The method according to any of points 1 to 17, wherein the suspension is applied in step b) by a method selected from spin coating, dip coating, knife coating, and spraying.

19. The method according to any of points 1 to 18, wherein the compaction of the suspension in step c) is achieved by means of an increase in the temperature, a reduction in the partial pressure of the solvent, or combinations thereof.

20. The method according to any of points 1 to 19, wherein, during the step of compacting the suspension in step c), at least 40 wt % of the solvent, preferably at least 50 wt % of the solvent, more preferably at least 75 wt % of the solvent, and very preferably at least 85 wt % of the solvent, is removed, based on the total weight of the solvent in the suspension to be applied.

21. The method according to any of points 1 to 20, wherein steps a), b) and c) are carried out a plurality of times, preferably two or three times.

22. The method according to any of points 1 to 20, wherein steps b) and c) are carried out a plurality of times, preferably two or three times.

23. The method according to any of points 1 to 22, wherein, in step d), the keeping of the coating obtained in step c) on the surface of the support structure in a vapor-containing atmosphere takes place at an elevated temperature in a water vapor-containing atmosphere.

24. The method according to any of points 1 to 23, wherein, in step d), the keeping of the coating obtained in step c) on the surface of the support structure in a vapor-containing atmosphere takes place at an elevated temperature in the range from 100 to 170° C., preferably 100 to 150° C., more preferably 100 to 121° C.

25. The method according to any of points 1 to 24, wherein the coating obtained in step c) is maintained in step d) on the surface of the support structure for 0.5 to 192 hours, preferably 2 to 96 hours, in a vapor-containing atmosphere at an elevated temperature.

26. The method according to any of points 1 to 25, wherein, in step d), the keeping of the coating obtained in step c) on the surface of the support structure takes place at an elevated temperature in an open system.

27. The method according to any of points 1 to 25, wherein, in step d), the keeping of the coating obtained in step c) on the surface of the support structure takes place at an elevated temperature in a closed system at a pressure which is above or below the atmospheric pressure.

28. The method according to any of points 1 to 27, wherein the partial pressure of the vaporous component in the atmosphere when the coating obtained in step c) is being kept on the surface of the support structure in step d) at an elevated temperature is established autogenously via the phase equilibrium or the phase equilibria of the species present at the selected temperature, or in a targeted way by means of one or more internal or external regulating facilities or regulating measures.

29. The method according to point 28, wherein a regulating facility or regulating measure is used which is an apparatus or of physical or chemical nature, or a combination of these.

30. The method according to any of points 1 to 29, wherein the crystals of a zeolite material or of a zeolite-like material in the coating formed in step d) have a size of 20 to 200 nm, preferably 30 to 100 nm.

31. The method according to any of points 1 to 30, wherein subsequent to step d) template species still present is removed by an aftertreatment, preferably a thermal aftertreatment, from the resultant composite material.

32. The method according to any of points 1 to 31, wherein subsequent to step d) one or more of the following steps are also carried out for the aftertreatment of the coating formed: calcination, extraction, thermal treatment, leaching, steam treatment, acid treatment, ion exchange, and mechanical shaping.

### EXAMPLE

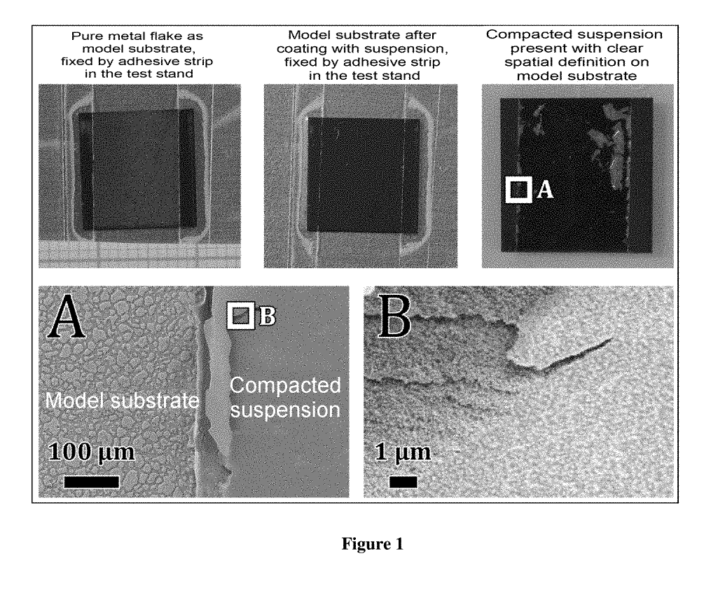

FIG. 1 to FIG. 3 show working examples of the method of the invention, using planar support systems as an example. The starting points for this example were planar metal plaques (12×12 mm) as a model substrate for the supported compaction and conversion of an aqueous suspension consisting of (i) nanoscale zeolite silicalite-1 (purely SiO₂-based zeolite of MFI topology) and (ii) noncrystallized network formers (amorphous SiO₂ species and/or dissolved SiO₂ species), and also (iii) unreacted template molecules.

According to step a), a suspension comprising the nanoscale zeolite material, the precursor compound of the zeolite material, and a template species was produced as follows:

First, the template (tetrapropylammonium hydroxide, “TPAOH”, 40 wt % in water) and deionized water were mixed in a 500 mL conical flask, the amounts being established in accordance with a TPAOH:H₂O molar ratio of 1:53.33. This solution was stirred using a stirring bar at 400 rpm for a few minutes 10 minutes). Added dropwise to this solution at around 1 drop per second, with further stirring, was tetraethyl orthosilicate (“TEOS”, Alfa Aesar, 98%). The amount of TEOS here was established such that the final solution had the following molar composition of network former (silicon via TEOS), template and water: Si:TPAOH:H₂O=1:0.36:19.2. This solution was stirred for a further 48 hours at room temperature at unchanged stirring speed in the conical flask, which was now closed. Taking account of the hydrolysis of TEOS, therefore, in the customary oxide notation, the mixture present after the aforesaid time was a so-called synthesis mixture with the following molar ratios: 1 SiO₂:0.18 TPA₂O:19.2 H₂O:4 ethanol, and had a pH of 12.6. This synthesis mixture was transferred to a stainless steel autoclave with PTFE insert (45 mL, Parr Instrument). The hydrothermal crystallization of the crystalline zeolite took place accordingly at 90° C. in an oven (90° C.) with air circulation function for 49 hours. After the 49-hour synthesis time, the autoclaves were removed from the oven and cooled to room temperature. The milky suspension consisting of the zeolitic nanocrystals, the unreacted silica species and the residues of template was utilized directly for spray coating (step b).

Spray coating took place by means of a commercial spray gun. Serving as model substrates were two stainless steel plaques (12×12 mm), and drying (step c): “compaction”) took place under identical ambient conditions (room temperature, atmospheric pressure), to give in each case a macroscopically dry layer (cf. FIG. 1).

Subsequently, the precursor compounds present in the compacted layer were converted (step d)), in a separate closed system in each case. For this purpose, after the above-described compaction step, the coated model substrates were kept in a water vapor atmosphere in a closed system (again 45 ml autoclave with PFTFE insert from Parr) at 155° C. for 66 hours. In practice, keeping was put into practice by means of a PTFE spacer with PTFE support plate, onto which the respective coated model substrate was placed with the coating pointing upward.

The water for establishing a vapor atmosphere for the conversion was provided via the addition of pure water (experiment V1) and also by the addition of silica gel (experiment V2, mixture of 50 wt % loaded silica gel and 50 wt % activated silica gel, based on the mass in the anhydrous state) on the base of the PTFE insert, so that the PTFE spacer undertook spatial separation of the model substrate and the water from one another (V1) and of the model substrate and the silica gel mixture (V2) from one another, resepcetively, and no direct contact was possible.

In both cases, V1 and V2, a sufficient amount of H₂O was present at 155° C. in the closed system to establish a relative humidity of 100%; in experiment V2, however, owing to the water sorption characteristics of the silica gel, a lower level of the water vapor partial pressure in the closed system is anticipated, particularly during the heating and cooling phase, but also during the isothermal phase at 155° C.; the silica gel mixture serves here to control the water vapor partial pressure.

After the stated 66 hours of maintenance in a vapor atmosphere, the autoclaves were cooled to room temperature, and the composite materials were removed, rinsed with deionized water and dried overnight at 75° C.

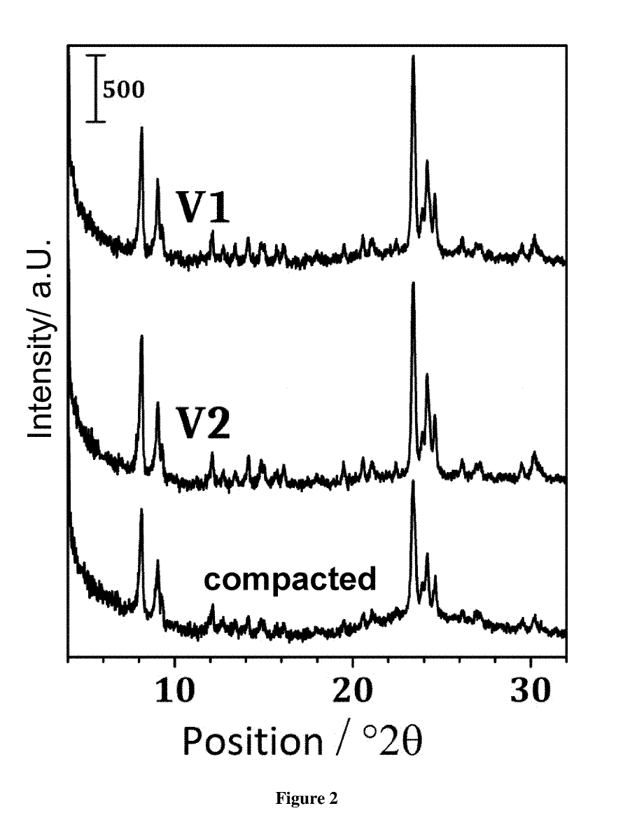

Comparison of the two resultant composite materials shows clearly that in both experiments there was sufficient water available to permit complete reaction of the initially amorphous network formers (precursor compound of the zeolite material) (see X-ray diffractrograms in FIG. 2: the success of the conversion is evident for both samples (V1 and V2) from a marked decrease in the amorphous phase in comparison to the compacted suspension, while the intensity of the characteristic MFI reflexes rises significantly).

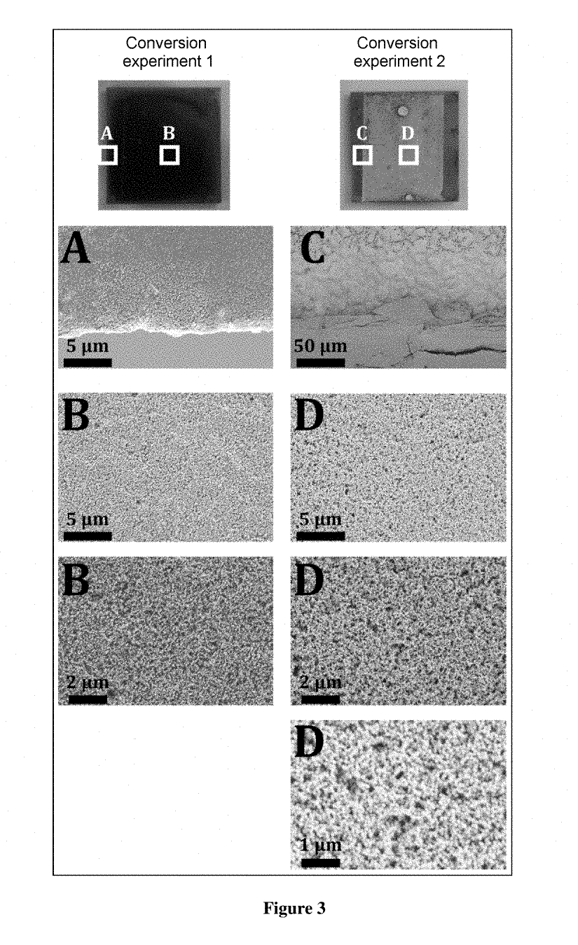

As is clearly apparent in FIG. 3, these experiments also show that at a high water vapor partial pressure (V1) during the conversion there is evidently condensation of water on the coated model substrate, leading to the “melting away” of the originally locally clearly defined layer. This effect is not observed when using the silica gel (V2).

FIG. 1: Photographs of the planar model substrate in uncoated state, fixed by adhesive strip on the test stand (top, left), immediately after coating by spray application of the suspension (top, center) and after compaction of the suspension (right, drying under atmospheric conditions, adhesive strip already removed here). Bottom: scanning electron micrographs of the compacted suspension on the model substrate (bottom left: left-hand half of image clearly shows the uncoated region (where the adhesive strip was during spray coating)). Letters indicate in each case the region of enlargement.

FIG. 2: X-ray diffractograms of the compacted suspension on the model substrate (“compacted”) and also of the vapor-treated compacted suspension in accordance with experiment 1 (“V1”) and experiment 2 (“V2”) layer on the metal plaques.

FIG. 3: Photographic pictures (top) and scanning electron micrographs (bottom) of the metal plaques with the converted compacted suspension according to experiment 1 (left) and according to experiment 1 (right). Letters indicate in each case the region of enlargement.

1. A method for generating a composite material with a support structure and a coating on the surface of the support structure, the coating comprising, as active component crystals of a zeolite material or of a zeolite-like material, with intercrystalline mesopores and/or macropores being formed in the coating,
characterized in that the method comprises the following steps:
a) providing a suspension which comprises nanoscale starting crystals of a zeolite material or of a zeolite-like material, and also precursor compounds of the zeolite material or zeolite-like material,
b) applying the suspension provided in step a) to the surface of the support structure,
c) compacting the suspension applied in step b) by at least partially removing the solvent that forms the liquid phase of the suspension, to yield a coating which comprises the starting crystals and the precursor compounds,
d) keeping the coating obtained in step c) on the surface of the support structure in a vapor-containing atmosphere at an elevated temperature, so that the precursor compounds present are converted into a zeolite material or a zeolite-like material and, together with the starting crystals, form the coating which comprises crystals of a zeolite material or of a zeolite-like material.

2. The method as claimed in claim 1,
wherein the providing of the suspension in step a) takes place by synthesis of the starting crystals by partial reaction of a reaction mixture which comprises (i) a solvent, (ii) the precursor compounds of the zeolite material or zeolite-like material, and also preferably (iii) a template species,
and wherein the suspension thus provided, with the starting crystals and unreacted precursor compounds present therein, is applied in step b) to the surface of the support structure, without prior isolation of the synthesized starting crystals.

3. The method as claimed in one of claims 1 and 2, wherein the nanoscale starting crystals have a size of from 20 to 200 nm.

4. The method as claimed in one of claims 1 to 3, wherein the coating formed in step d) is a coating which is free from binder material.

5. The method as claimed in one of claims 1 to 4, wherein the zeolite material or zeolite-like material formed during the conversion in step d) connects starting crystals in the coating.

6. The method as claimed in one of claims 1 to 5, wherein the support structure is formed from a metallic or ceramic material.

7. The method as claimed in one of claims 1 to 6, wherein the precursor compounds of the zeolite material or zeolite-like material in the suspension provided in step a) comprise at least one type of a silicon compound which is selected from silicic acid, salts of silicic acid and silicic acid esters.

8. The method as claimed in as claimed in one of claims 1 to 7, wherein the precursor compounds of the zeolite material or zeolite-like material in the suspension provided in step a) comprise at least one type of an aluminum compound which is selected from aluminates, aluminum salts, hydrated aluminum and aluminum alkoxides.

9. The method as claimed in one of claims 2 to 8, wherein the template species is a tetraorganoammonium cation or a tetraorganophosphonium cation.

10. The method as claimed in one of claims 1 to 9, wherein, during the step of compacting the suspension in step c), at least 40% by weight of the solvent is removed, based on the total weight of the solvent in the suspension to be applied.

11. The method as claimed in one of claims 1 to 10, wherein, in step d), the keeping of the coating obtained in step c) on the surface of the support structure takes place in a water vapor-containing atmosphere at an elevated temperature in the range from 100 to 170° C.

12. The method as claimed in one of claims 1 to 11, wherein steps b) and c) are carried out a plurality of times.
